(19) United States
(12) Patent Application Publication
(10) Pub. No.: US 2018/0154987 A1
(43) Pub. Date: Jun. 7, 2018

(54) GAS ASSISTED INJECTION MOLDED BOAT TOP

(71) Applicant: RTM, LLC doing business as RT Marine, Columbia, SC (US)

(72) Inventors: Henry Bradley Huff, JR., Pomaria, SC (US); Chad Haskell Boozer, Irmo, SC (US); Richard Dalton Lambert, Chapin, SC (US)

(73) Assignee: RTM, LLC doing business as RT Marine, Columbia, SC (US)

(21) Appl. No.: 15/366,079

(22) Filed: Dec. 1, 2016

(51) Int. Cl. B63B 17/02; B29C 45/17

(52) U.S. Cl. CPC B63B 17/02; B29K 2055/02; B63B 2017/026; B29C 45/174

(57) ABSTRACT

Synthetic polymer boat tops are made by injection molding processes in which channels for power cables, leads, and the like are molded simultaneously in situ with the tops using gas assistance methods.

### BACKGROUND

Many fishing vessels, cruisers, ski boats and the like utilize overhead covers to shield boaters from the sun. Covers often are added after a boat has been purchased from a retailer, or the covers are installed on older model boats. Conventional aftermarket covers unfortunately suffer from a variety of drawbacks. For instance, desirable amenities such as lights and speakers that are added to the covers usually result in unsightly, exposed electrical wires running from power supplies to the added equipment.

Another drawback to conventional boat covers is considerable weight. For example, well known fiberglass covers may weigh one-hundred and fifty pounds or more for boats of eighteen to twenty-five feet in length. Additionally, a fiberglass cover can require a day or more to produce.

What is needed in the boating industry is a lightweight boat top that can be produced relatively rapidly and economically with wire channels that are integral to the boat top.

### BRIEF SUMMARY OF THE DISCLOSURE

The present disclosure is directed in general to lightweight boat tops that can be produced in approximately two minutes at a fraction of the cost of conventional boat covers. The boat tops described in detail herein are aesthetically pleasing and economical to manufacture with wire channels formed in situ.

According to one embodiment of the disclosure, a boat top includes an injection-molded, polymer upper portion and a complementary polymer inner portion molded therewith; and a wire chase formed contemporaneously by gas injection with the injection-molded upper and inner portions. The wire chase may be formed between the upper and inner portions and configured to accommodate wiring between those portions.

In this embodiment, the polymer may be polyethylene, polypropylene, polyacrylonitrile, polyvinyl chloride, or any suitable injection molding grade of material. More particularly, the polymer may be acrylonitrile butadiene styrene.

Also in this aspect of the disclosure, the inner portion may include a recess in communication with the chase, and the recess may be configured to receive a device such as a speaker, a control panel, and/or a light. The wiring may run or pass through the chase to the device.

Further, this embodiment may include framework that can be mated to the boat top and to a boat. The framework may include a hollow tube in communication with the chase, and the hollow tube may receive the wiring from the chase to power a device such as a speaker, a control panel, and/or a light.

In another embodiment according to the disclosure, a boat top system may include a thermoplastic boat top having an injection molded upper portion and a complementary inner portion and a channel formed therebetween by injected gas, the channel configured to conceal power cables within the boat top; and framework for mating the boat top to a boat. In this aspect, the thermoplastic boat top may be made of a material such as polyethylene, polypropylene, polyacrylonitrile, polyvinyl chloride, acrylonitrile butadiene styrene, or other suitable injection molding material.

Also in this embodiment, the inner portion may include a recess in communication with the channel. The recess may receive or hold a device including a speaker, a control panel, and/or a light. The cables may run or pass through the channel to the device, and the framework may include a hollow tube in communication with the channel. The hollow tube may receive the cables from the channel to power the device.

In a further embodiment, a method for molding a thermoplastic boat top may include steps such as providing a mold having at least one gas channel defined therein and at least one valve gate formed therein; providing a gas port in communication with the gas channel; providing a resin port in communication with the valve gate; heating a quantity of resin to a molten state to achieve a desired viscosity; injecting the molten resin through the resin port into the mold; injecting gas from the gas port into the gas channel at a desired pressure to form wire channels in the molten resin; and forming a boat top with the wire channels therein as the molten resin cools in the mold.

In this method, the resin may be any suitable injection molding grade of thermoplastic material. More specifically, the resin may be about 20 kg to about 30 kg of acrylonitrile butadiene styrene material.

Also in this exemplary method, the desired pressure to inject the gas from the gas port into the gas channel may range from about 1,000 psi to about 2,000 psi. The desired pressure may have an equivalent clamp tonnage of about 2000 metric tons to about 4000 metric tons.

Furthermore, the gas port according to the method may be multiple gas ports, and the valve gate may be multiple valve gates.

Also according to the exemplary method, the wire channels may be aligned with conduits formed in a framework, and the framework may be arranged or formed to connect the boat top to a boat with the conduits being configured to enclose cables therein.

Additional aspects of the present subject matter are set forth in, or will be apparent to, those of ordinary skill in the art from the detailed description herein. Also, it should be further appreciated that modifications and variations to the specifically illustrated, referred and discussed features and elements hereof may be practiced in various embodiments and uses of the disclosure without departing from the spirit and scope of the subject matter. Variations may include, but are not limited to, substitution of equivalent means, features, or steps for those illustrated, referenced, or discussed, and the functional, operational, or positional reversal of various parts, features, steps, or the like. Those of ordinary skill in the art will better appreciate the features and aspects of such variations upon review of the remainder of the specification.

### BRIEF DESCRIPTION OF THE DRAWINGS

A full and enabling disclosure of the present subject matter, including the best mode thereof, directed to one of ordinary skill in the art, is set forth in the specification, which makes reference to the appended figures, in which:

FIG. 1 is a perspective view of one embodiment of a gas assisted, injection molded boat top system in an intended use environment according to the present disclosure;

FIG. 2 is a perspective view of an underside of a boat top as in FIG. 1, particularly showing installation of exemplary workpieces;

FIG. 3 is perspective, phantom view of the boat top underside as in FIG. 2;

FIG. 4 is a perspective, phantom view of the boat top system as in FIG. 1;

FIG. 5 is a plan view of a portion of a process for molding a boat top as in FIG. 1 according to another aspect of the disclosure, particularly showing a plot of plastic and gas melt front time;

FIGS. 6A, 6B, and 6C show an exemplary resin filling pattern according to the process in FIG. 5;

FIG. 7 is a graph showing fill pack and gas injection during the filling process as in FIGS. 6A, 6B, and 6C;

FIG. 8 is a graph of clamp tonnage over time during fill pack and gas injection as in FIGS. 6A, 6B, and 6C;

FIG. 9 is a bottom plan view of a boat top according to another aspect of the disclosure, particularly showing gas channels (in phantom for clarity) relative to various filling gates;

FIG. 10 shows various fill thicknesses of the boat top as in FIG. 9;

FIG. 11 is a partial detailed view of a portion of the boat top as in FIG. 9 showing a gas channel access;

FIG. 12 is a perspective view of the portion of the boat top as in FIG. 11;

FIG. 13 is a perspective view of the portion of the boat top as in FIG. 11, particularly showing experimental gas flow paths (in phantom for clarity);

FIG. 14A is a perspective view of the portion of the boat top as in FIGS. 11 and 13, particularly showing an experimental, non-uniform gas access;

FIG. 14B is a perspective view of an experimental component that may be used with the gas access as in FIG. 14A;

FIGS. 15A, 15B, 15C, 15D, 15E, and 15F show an exemplary resin filling pattern used to form the top as in FIG. 9;

FIG. 16 is a graph of clamp tonnage over time during the filling process as in FIGS. 15A-15F, particularly showing a bottom perspective view of the boat top as in FIG. 9;

FIG. 17 is a graph of clamp tonnage over time during a filling process similar to FIGS. 15A-15F, particularly showing a top perspective view of the boat top as in FIG. 9F;

FIG. 18 is a bottom plan view of a boat top according to another aspect of the disclosure, particularly showing gas channels (in phantom for clarity) relative to various filling gates;

FIG. 19 is a bottom plan view of a boat top according to another aspect of the disclosure, particularly showing modified gas channels (in phantom in inset for clarity);

FIG. 20A shows an exemplary filling process clamp tonnage according to the disclosure;

FIG. 20B shows exemplary material data used in FIG. 20A;

FIG. 21 shows an exemplary overflow pin method according to the disclosure;

FIG. 22 shows a plan view of an overflow and associated pin runner and sub-gate;

FIG. 23 shows an overflow pin location according to an aspect of the disclosure; and

FIG. 24 shows a partial boat top and an enlarged portion in inset showing an exemplary gas nozzle according to another aspect of the disclosure.

### DETAILED DESCRIPTION

Detailed reference will now be made to the drawings in which examples embodying the present subject matter are shown. The detailed description uses numerical and letter designations to refer to features of the drawings.

The drawings and detailed description provide a full and written description of the present subject matter, and of the manner and process of making and using various exemplary embodiments, so as to enable one skilled in the pertinent art to make and use them, as well as the best mode of carrying out the exemplary embodiments. However, the examples set forth in the drawings and detailed descriptions are provided by way of explanation only and are not meant as limitations of the disclosure. The present subject matter thus includes any modifications and variations of the following examples as come within the scope of the appended claims and their equivalents.

Although detailed embodiments are disclosed as required, it is to be understood that the embodiments are merely exemplary. The figures are not necessarily to scale, and some features may be exaggerated to show details of particular components. Therefore, specific structural and functional details disclosed herein are not to be interpreted as limiting, but merely as a basis for the claims and as a representative basis for teaching one skilled in the art to variously employ the various embodiments of the present disclosure.

Unless defined otherwise, all technical and scientific terms used herein have the same meaning as is commonly understood by one of ordinary skill in the art to which this disclosure belongs. In the event that there is a plurality of definitions for a term herein, those in this section prevail unless stated otherwise.

Wherever the phrase “for example,” “such as,” “including” and the like are used herein, the phrase “and without limitation” is understood to follow unless explicitly stated otherwise. Similarly “an example,” “exemplary” and the like are understood to be non-limiting.

The term “substantially” allows for deviations from the descriptor that do not negatively impact the intended purpose. Descriptive terms are understood to be modified by the term “substantially” even if the word “substantially” is not explicitly recited.

The term “about” when used in connection with a numerical value refers to the actual given value, and to the approximation to such given value that would reasonably be inferred by one of ordinary skill in the art, including approximations due to the experimental and or measurement conditions for such given value.

The terms “comprising” and “including” and “having” and “involving” (and similarly “comprises”, “includes,” “has,” and “involves”) and the like are used interchangeably and have the same meaning. Specifically, each of the terms is defined consistent with the common United States patent law definition of “comprising” and is therefore interpreted to be an open term meaning “at least the following,” and is also interpreted not to exclude additional features, limitations, aspects, etcetera. Thus, for example, “a device having components a, b, and c” means that the device includes at least components a, b and c. Similarly, the phrase: “a method involving steps a, b, and c” means that the method includes at least steps a, b, and c.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

While terms such as “first,” “second,” “third,” and “fourth” are used to identify various components of various embodiments, unless otherwise stated in the context in which those terms are utilized, such terms are simply an arbitrary naming convention to distinguish between pieces and parts. For instance, a “first half” and a “second half” are not limited relative to each other in importance nor chronologically. The “first half” could just as well be called the “second half” and vice versa.

Any discussion of prior art in the specification should in no way be considered as an admission that such prior art is widely known or forms part of common general knowledge in the field.

The various embodiments of the disclosure and/or equivalents falling within the scope of present disclosure overcome or ameliorate at least one of the disadvantages of the prior art, or provide a useful alternative.

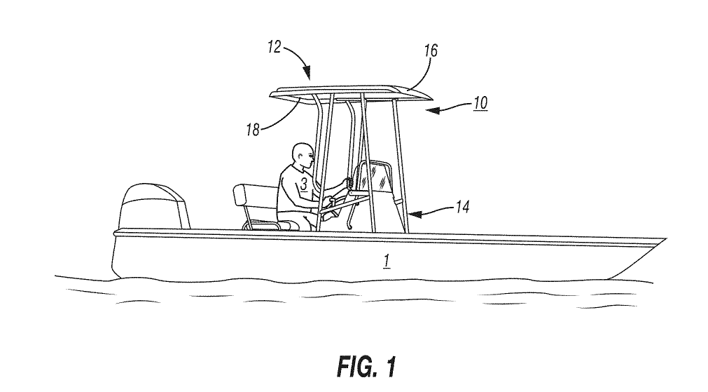

Turning now to the figures, FIG. 1 shows a vessel or boat designated by reference numeral 1. Here, the boat 1 is equipped with a boat top system, broadly identified by the reference numeral 10. The boat top system 10 operates to shade an operator 3 from sunlight and also incorporates various amenities as described below. The boat top system 10 may be installed during manufacture of the boat 1 or in the aftermarket.

FIG. 1 further shows that the boat top system 10 may broadly include a boat top, cover or cap 12 and a support structure or frame 14. In this example, the boat top 12 has an upper or top side or face 16 and a contiguous or unitary underside, inner face or ceiling 18. The frame 14 may be made of stainless steel, aluminum or other metals, or other materials such as high density polyethylene (HDPE) or treated wood. As shown, the cover 12 is attached or connectable to the frame 14, which in turn is installed or attached to the boat 1.

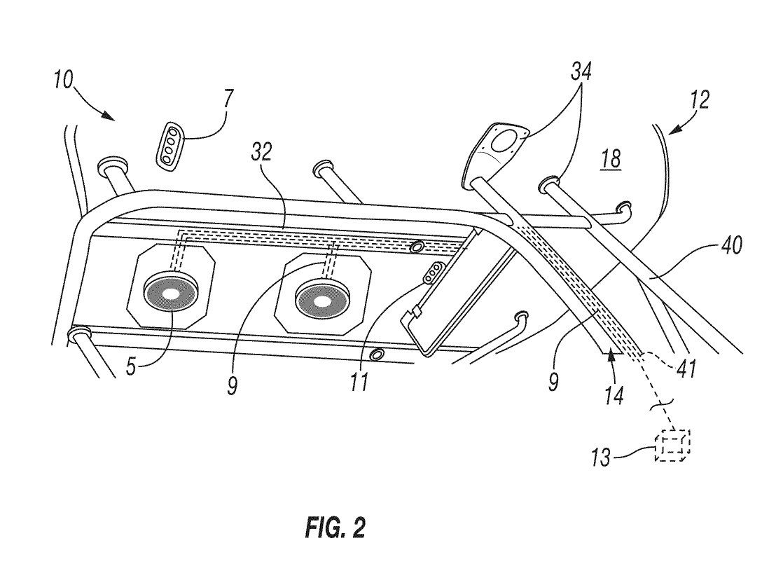

FIG. 2 most clearly shows a detailed portion of the underside 18 of the cover 12. As shown, the support structure 14 may include a variety of tubes, supports, or poles 40 to support the cover 12. In this example, at least some of the tubes 40 terminate at various attachment points such as pedals, pads, or bases 34, which are connected to the underside 18 by snap-fits, welds and the like. Furthermore, some of the tubes 40 may be hollow conduits as indicated schematically by reference number 41 to permit wires or cables 9 (also shown schematically in phantom for clarity) to extend or run from various fixtures such as speakers 5, lights 7 and controls 11 to a power source such as a boat battery 13 that may be stored at a distance from the cover 12, as indicated by the broken lines. Moreover, the wires 9 may extend from the various fixtures 5, 7, 11 into wiring or wire chase channels 32 formed within the top 12. Additional details of the boat top system 10 and an exemplary gas assisted injection molding (GAIM) process of forming the boat top 12 are described in detail below.

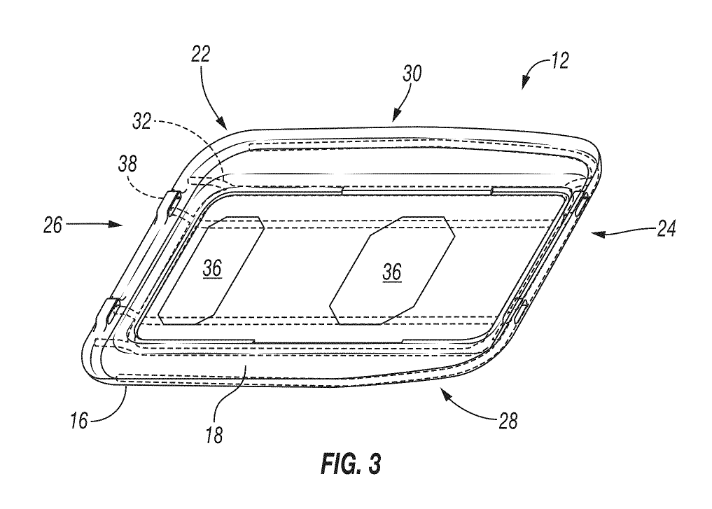

With reference now to FIG. 3, the exemplary top 12 is shown partially in phantom for clarity. Here, the interior wall or face 18 is somewhat concave while the complementary outer portion 16 is relatively convex. Of course, the extent or grade of these convex/concave characteristics may be adjusted during a forming process described below to accommodate end-user requirements. Also shown in the example of FIG. 3, a thickness of the top 12 may be approximately 7 millimeters (mm) (about one-quarter inch (¼″)) except for the wire chase channels 32, which may be approximately 20 mm in thickness to accommodate wires as described above with respect to FIG. 2. The exemplary concavity and thicknesses contribute to a lighter weight, which makes the top 12 easier to handle and stackable with other tops like the top 12. More specifically, the top 12 may weigh about 45 pounds (lbs.) to about 50 lbs., which is at least half the weight of a conventional fiberglass or metal top of similar dimensions. These advantages save production costs, transportation energy and costs, and require less storage or shelf space in retail establishments. The lighter weight top 12 also makes a vessel less top heavy and less susceptible to tipping and capsizing (see, e.g., boat 1 in FIG. 1). Likewise, the boat 1, when equipped with the top 12, will have a greater weight bearing capacity and/or freeboard. Still further, due to the streamlined and lighter weight top 12, installation of the top 12 is easier than installation of heavier, cumbersome, conventional covers.

As FIG. 3 particularly shows, the exterior 16 and the interior 18 terminate at a lip or perimeter 22 defined by a leading, front, or forward (bow) edge 24, a trailing, rear, or stern (aft) edge 26, a left or port edge 28, and a right or starboard edge 30. As this example shows, the interior 18 may include one or more speaker recesses or nests 36 (for speakers 5 as in FIG. 2), and the edges 24, 26 may include one or more light recesses or nests 38 (for light fixtures 7 as in FIG. 2). Also shown, there are six (6) wire chase channels 32 in which the two middle channels 32 in this example may accommodate electrical wiring (see, e.g., wires 9 in FIG. 2) for front and aft speaker boxes at areas 36 (see, e.g., speakers 5 in FIG. 2). The next two channels 32 moving outward in a direction toward the edges 28, 30 are for housing wires to provide power to the top 12. Finally, the outermost channels 32 provide wiring conduits to power front and aft lights at areas 38. Although six channels 32 are shown in FIG. 3, fewer or additional channels 32 can be provided to accommodate various end-user needs, and the various positions of the channels relative to various amenities can be altered and are not limited to the arrangement just described. An example operation of forming the channels 32 is explained below.

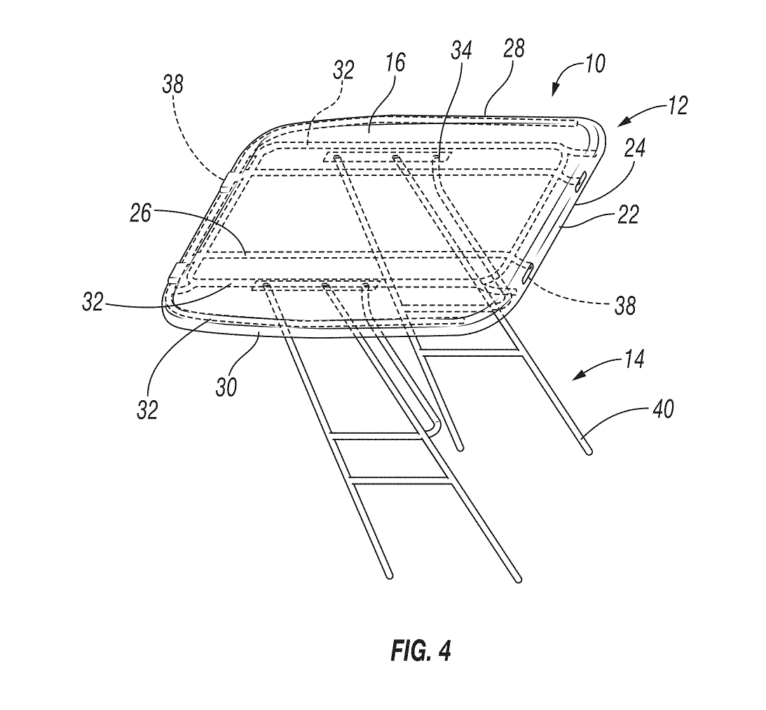

Turning to FIG. 4, there is shown in perspective the top 12 and the frame 14 snapped, welded, screwed, or otherwise attached together to form the boat top system 10. Here, as introduced above, the exterior 16 and the interior 18 terminate at the perimeter 22, which is formed by the forward edge 24, the rear edge 26, the port edge 28, and the starboard edge 30. As shown, the various rods 40 terminate at the attachment points 34 opening into various wire conduits 32 to receive wiring therethrough as detailed above.

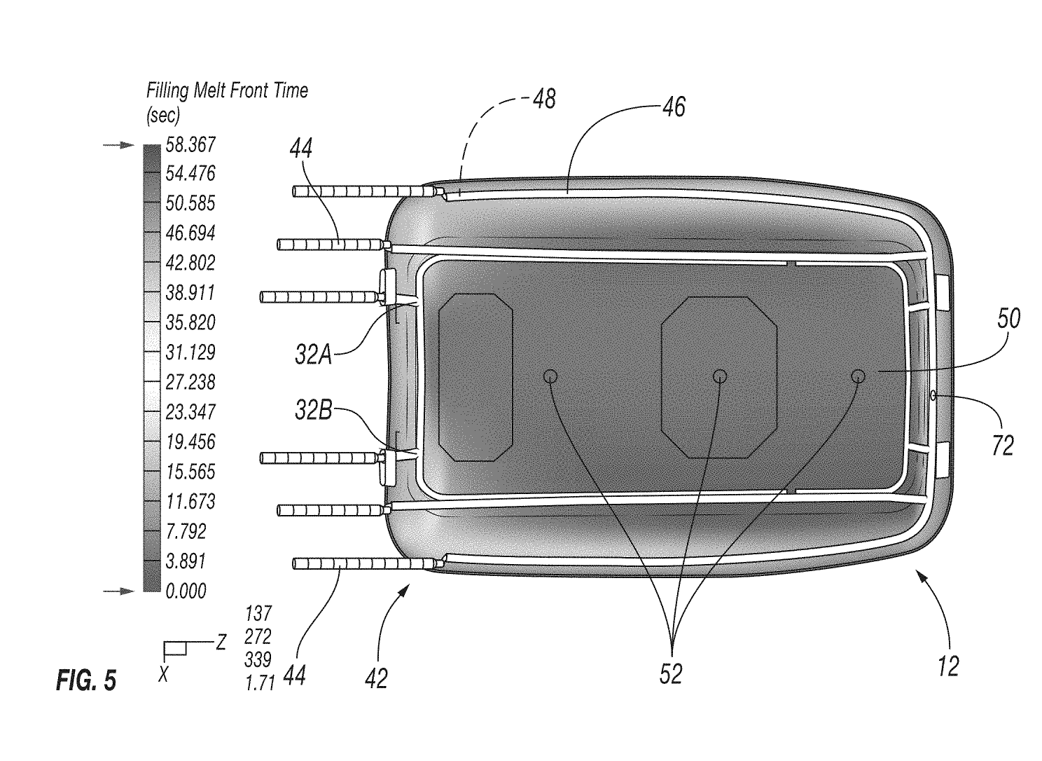

FIG. 5 shows an aspect of the disclosure in which a boat top mold 42 is provided with one or more plastic overflow wells 44 in communication with gas assist channels or cavities 46 to form the boat top 12 using the GAIM process disclosed herein. As shown, the mold 42 may be made of P20 steel to ensure a high gloss finish in the top 12. In an exemplary first stage or filling phase shown in FIG. 5, a shot load of material 50 sufficient to fill and pack the mold 42 was used. In this exemplary first stage, the load was 30 kilograms (kg) of resin 50, optimally 24 kg, and was injected using three (3) plastic injection ports 52 at a maximum of 16,000 pounds/inch (psi) (approximately 110 megaPascals (MPa)). This arrangement resulted in clamp tonnage of approximately 3000 metric tons.

In a second stage according to FIG. 5, gas 48 flows into the gas assist channels 46 from a port 72 at a relatively low pressure to push the resin 50 throughout the mold 42 to ensure thorough distribution or packing of the plastic 50. The resin 50 may be a thermoplastic polymer such as ABS (acrylonitrile-butadiene-styrene), nylon or the like, which will begin to shrink at it cools. Thus, the flow rate of the gas 48 into the channels 46 must be monitored and adjusted according to the rate of shrinkage of the material 50. ABS has superior injection molding qualities but other polyblends may be used as the resin 50 depending on desired tensile strength, ultraviolet (UV) light resistance, paint grade, and other requirements.

As briefly noted above, the gas channels 46 of FIG. 5 are in communication with respective overflow wells 44. The gas channels 46 serve at least two purposes in this example. First, one or more of the gas channels 46 assist in plastic packing as the resin 50 cools to create proper structure. Second, one or more of the gas channels 46 serve to create wire chases 32A, 32B in the final product 12.

In a third gas injection-overflow stage, a desired number of overflow wells 44 as shown in FIG. 5 are opened to allow gas 48 to push the resin 50 from the channels 46 to form the wire chases 32A, 32B. As introduced above, the wire chase channels 32A, 32B are used for hiding wiring of the boat top 12. Although 6 overflow wells 44 and 6 channels 46 are used in this embodiment, others may have varying numbers of gas channels 46 depending on the final form of product desired.

Experiment One

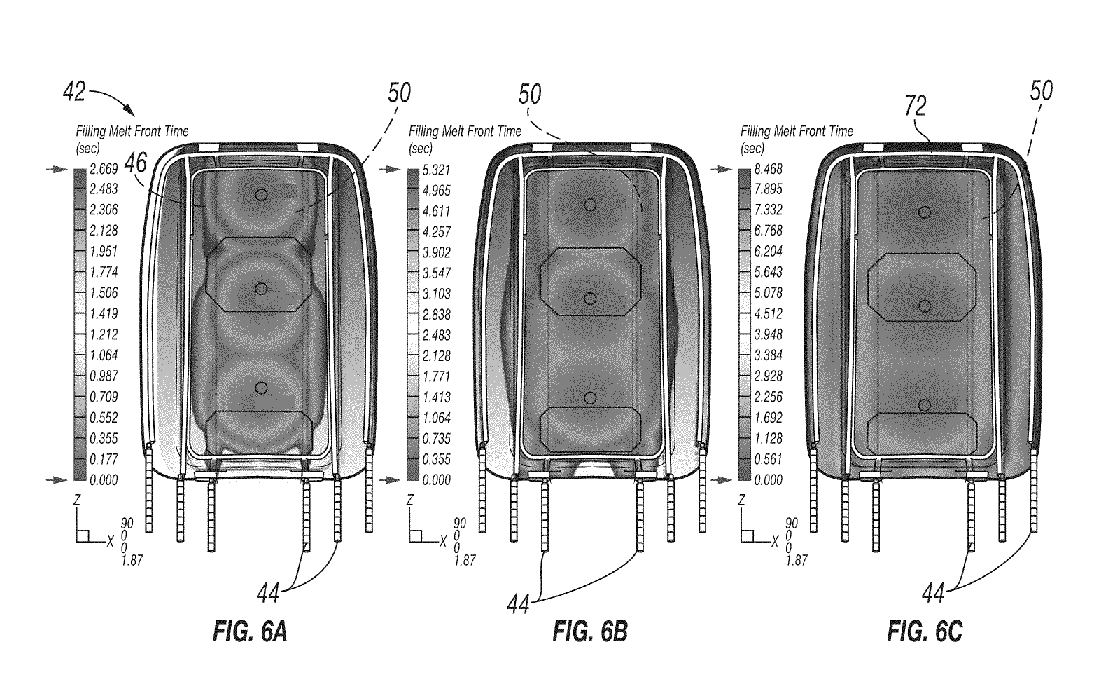

Turning now to FIGS. 6A, 6B and 6C, an exemplary first stage plastic filling pattern in the mold 42 is most clearly shown. FIG. 6A shows the molten resin 50 being initially injected into the mold 42 at three plastic injection ports 52. At this stage, neither the cavities 46 nor the gas port 72 are being employed. The resin 50 is shown spreading across the mold 42 in FIG. 6B and after about 8 seconds as shown in FIG. 6C, the resin 50 has spread throughout the mold 42.

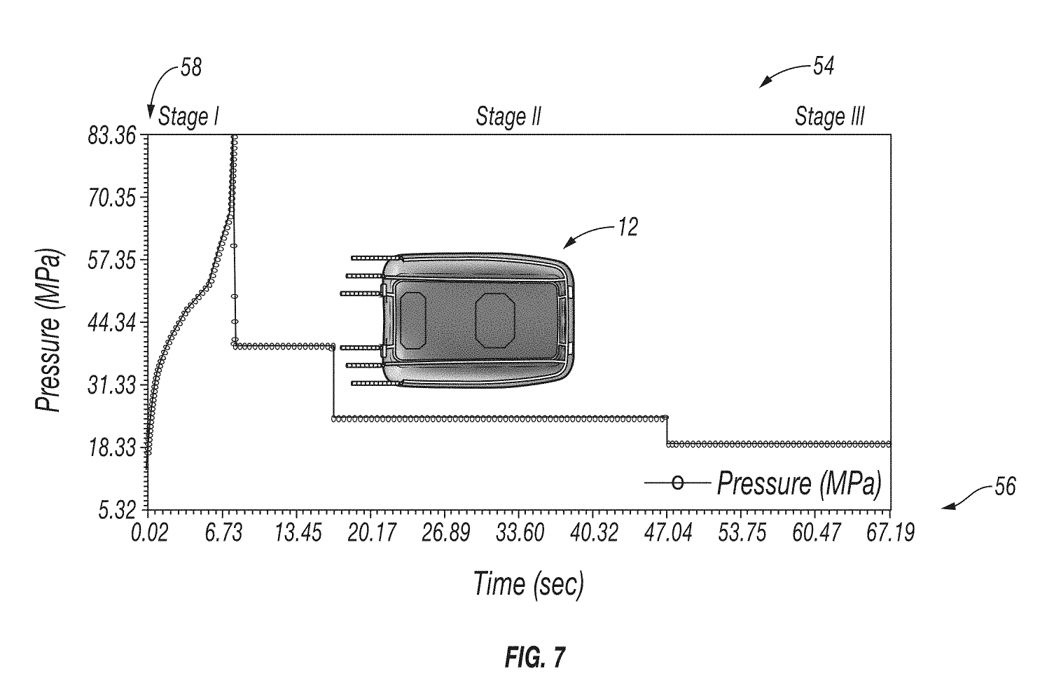

In FIG. 7 a chart 54 shows estimated time (seconds) along x-axis 56 and pressure along y-axis 58. Here, a theoretical filling pressure in Stage I would require a relatively high ˜83 MPa using the mold 42 and the three plastic injection ports 52 as shown in FIGS. 6A, 6B and 6C. In Stage II, the theoretical pressure would be stepped down to approximately 20-22 (and as high as 40) MPa for approximately 40 seconds to pack the resin. In Stage III, the pressure would be reduced to approximately 18 MPa for approximately 20 seconds while the overflow wells 44 (FIG. 6C) are opened to remove resin from channels 46 that will be used to form conduits for hidden wires.

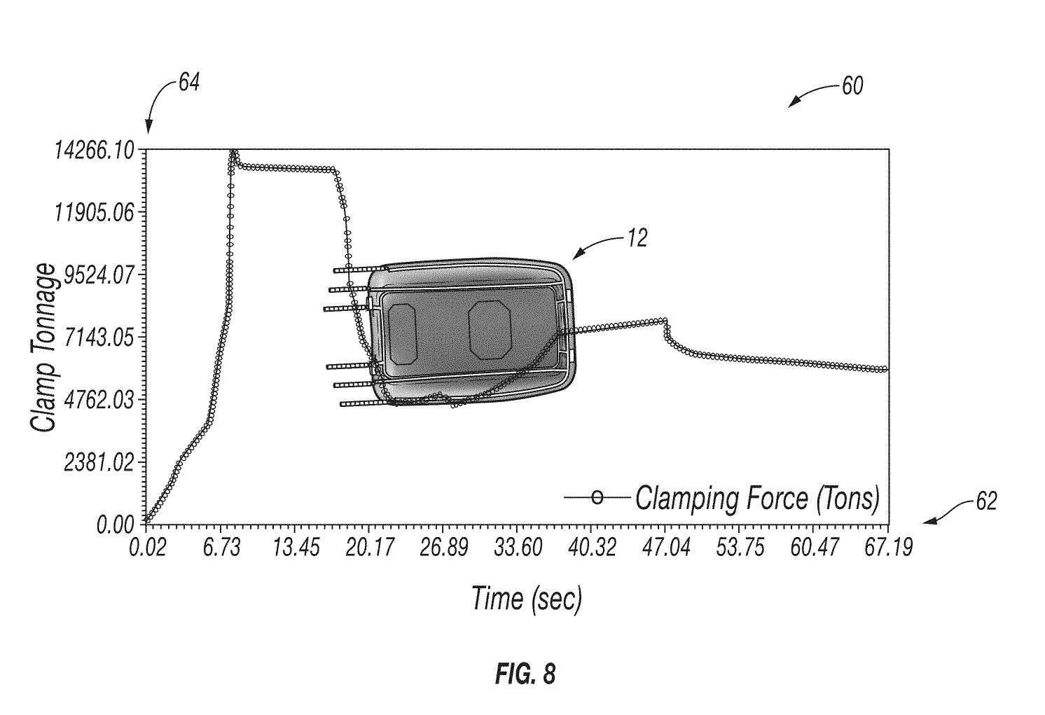

In conjunction with FIG. 7, FIG. 8 shows theoretical clamp tonnage along y-axis 64 of chart 60 exceeding 14266 metric tons by approximately 7 seconds as shown along x-axis 62 during filling Stage I. Such clamp tonnage is impractical leading the inventors to conclude that the experimental pressures and clamp tonnage of Experiment One had to be reduced to more practical levels to produce the desired boat tops 12. Further experiments revealed that more injection locations were desirable to reduce these numbers.

Experiment Two

The boat top 12 as shown in FIGS. 7 and 8 would use approximately 30 kg of resin 50. By adjusting the quantity and locations of the injection ports 52 (e.g., FIG. 6C) as well as the injection pressure and clamp tonnage, approximately 24 kg of resin 50 can be utilized to form, for example, an 88-inch boat top 12 weighing approximately 45 lbs. to about 50 lbs. This can be accomplished at approximately 3000 clamp tonnage using six valve injection ports.

Such an optimized boat top 12 is approximately ⅓ of the weight of a conventional fiberglass boat cover, and the boat top 12 can be produced at a rate of about one per 1-2 minutes compared, for instance, to a fiberglass cover that may take a day to produce; i.e., one fiberglass cover per day. Furthermore, the GAIM boat top 12 costs at least four times less to produce than known boat covers. The gas-assisted, injection molding process described above can be used to mold boat tops in other sizes and is not limited to the exemplary 88-inch top.

Experiment Three

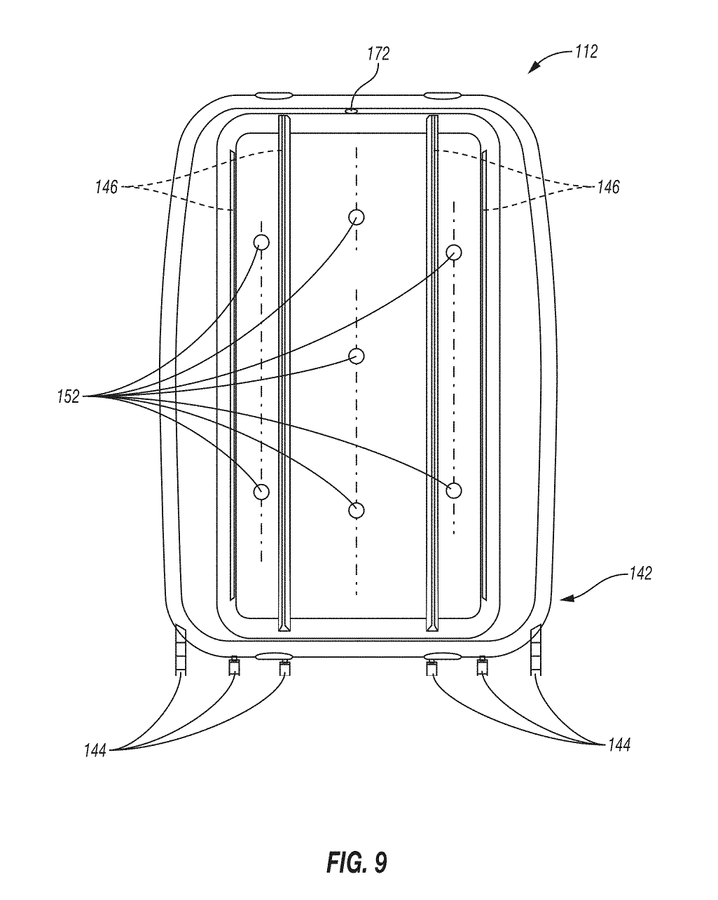

Turning now to FIG. 9, another aspect of the disclosure is shown in which a boat top mold 142 is provided with at least one gas port or nozzle 172 in communication with gas channels 146 to form the boat top 112 using GAIM processes as disclosed herein. As shown, the mold 142 may be made of P20 steel to ensure a high gloss finish in the top 112. In the exemplary process shown in FIG. 9, six (6) overflow wells 144 and seven (7) outflow wells or valve gates 152 are utilized. Here, molten resin is ejected under relatively high pressure at the valve gates 152 in a first filling stage. In a second packing stage, lower pressure gas may be injected along the gas assist channels 146 to ensure proper resin distribution in the mold 142. The gas assist channels 146 also serve to form one or more wire chase channels in the top 112 to conceal wiring, cables and the like within the boat top 112. Finally, in a third overflow stage, the overflow wells 144 are opened to clear resin from the wire chase channels.

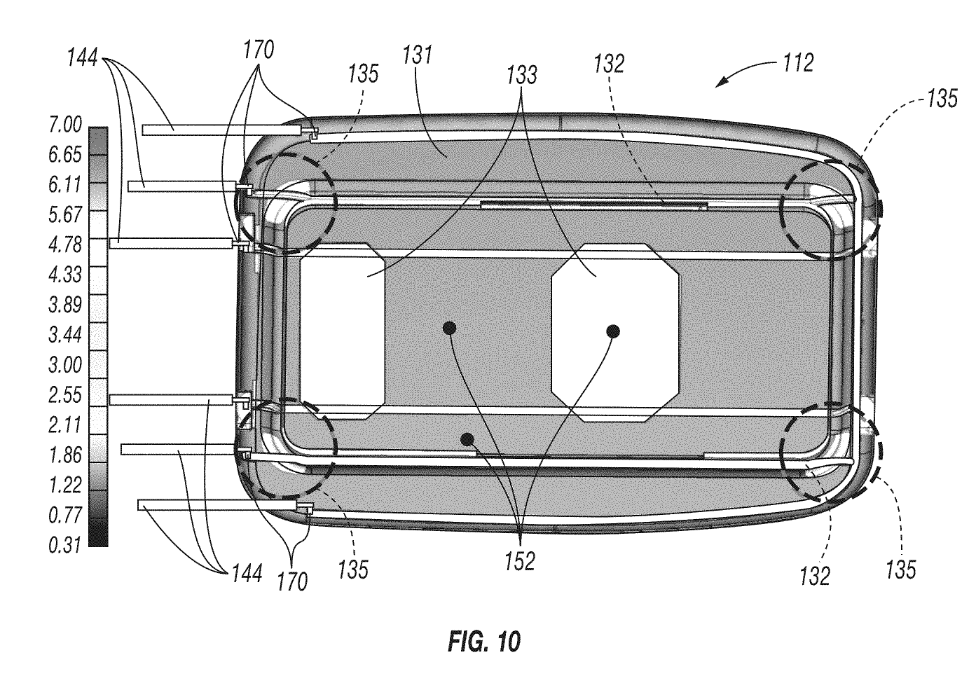

FIG. 10 shows that an exemplary thickness of the top 112 as in FIG. 9 may be approximately 7 mm (about one-quarter inch (¼″)), designated generally by element number 131, except for the wire chase channels 132, which may be approximately 20 mm in thickness to accommodate embedded wires as described above. Additionally, two areas 133 shown in this experimental top 112 are approximately 3.2 mm in thickness, which were been determined by the inventors to be less than optimal. FIG. 10 also shows that corner wall sections 135 were thicker than the general thickness 131. Subsequent gas flow and resin adjustments resulted in strengthening areas 133 by thickening those areas in later runs for greater structural strength.

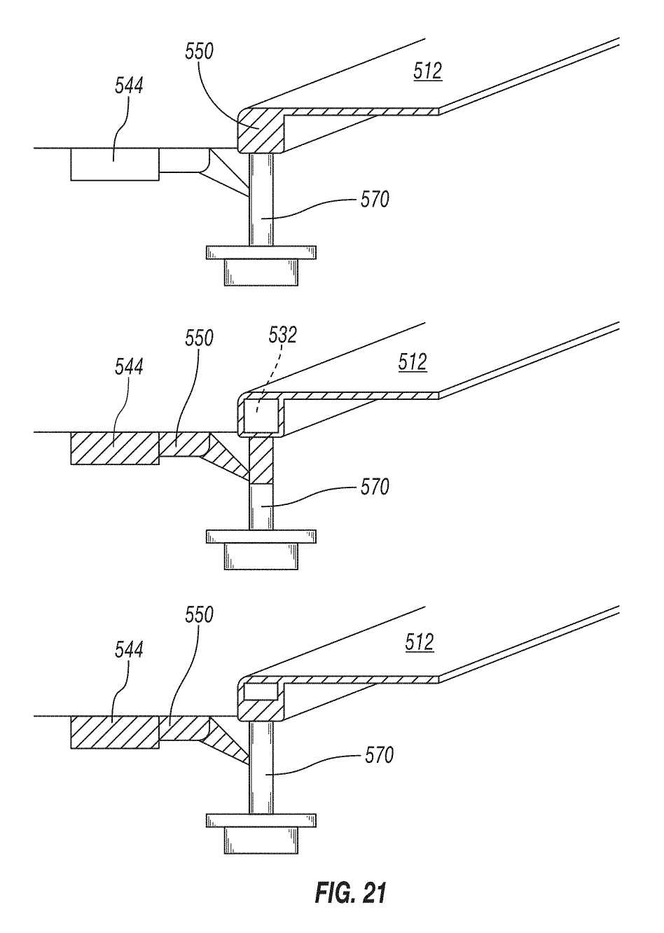

FIG. 10 also shows overflow pins 170. As explained in detail below with respect to FIG. 21, such overflow pins are opened or retracted to remove excess plastic from the wire chases and push the excess plastic into the overflow wells 144.

Experiment Four

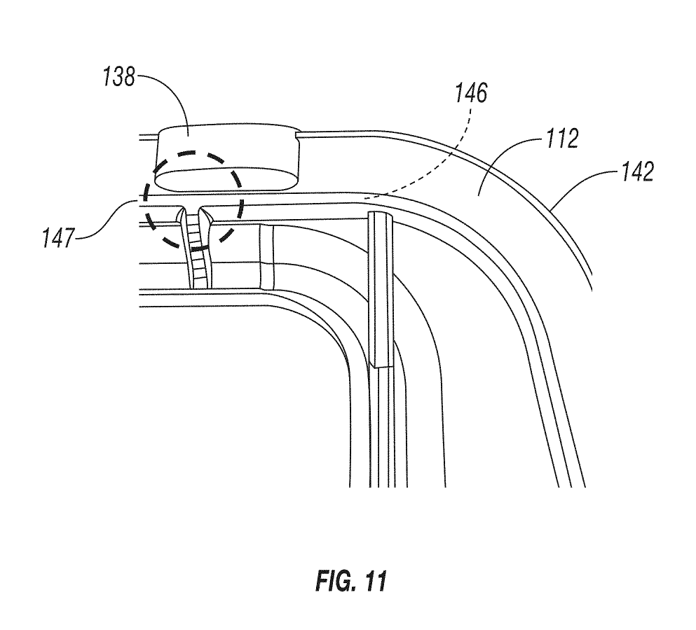

Turning to FIG. 11, a further experiment revealed that access is required to the gas channel 146 in the top 112 to allow wires to be fed therethrough. The inventors experimented with modifying the mold 142 and a light housing 138 as well as drilling holes at area 147 into the gas channel 146.

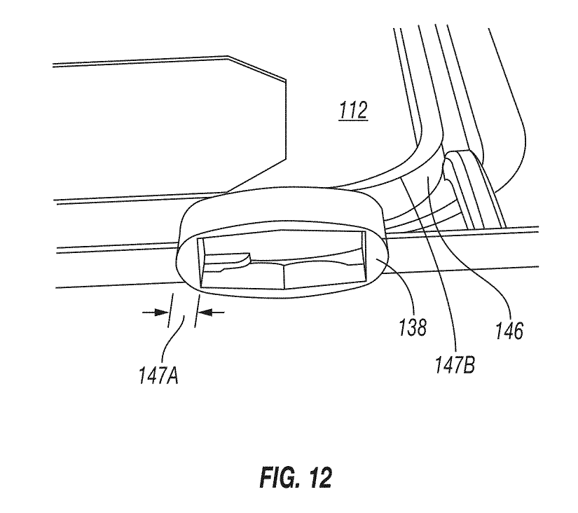

FIG. 12 further shows the top 112 and its light housing 138 as in FIG. 11.

Here, a section 147A of the light housing 138 is approximately 15 mm in thickness, and a radius 147B of one of the cavities 146 is too thick. The inventors discovered that these non-uniform thicknesses may cause sink and process problems, and so, discovered that a consistent thickness, e.g., less than about one-quarter of an inch (V) around the light housing 138, is desirable.

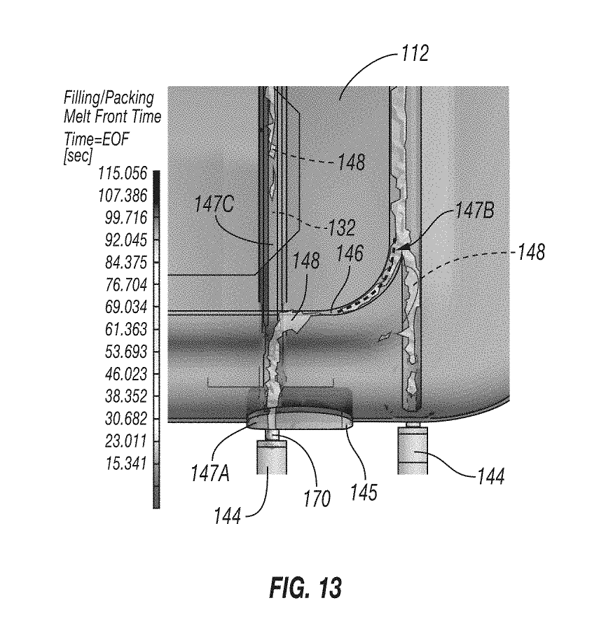

FIG. 13 most clearly shows how the gas 148 can flow in undesirable directions due to the thick radius 147B on one of the injection molding style ribs, which can cause the gas 148 to “jump” between gas channels 146. Here, in Stage III, the pin 170 is retracted to allow the gas 148 to push resin from the channel 146; however, due to the radius problem noted above, plastic remained in the channel 146 at area 147C instead of forming a wire chase 132. Thus, as noted above, the inventors determined to reduce the radius as shown by dashed line 147B.

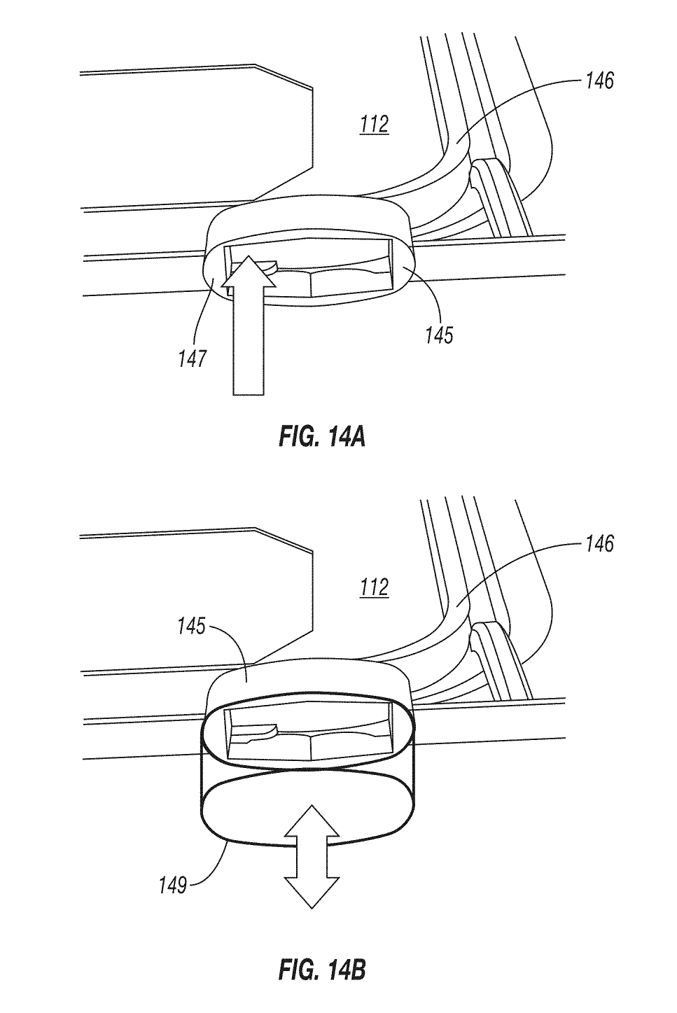

FIGS. 14A and 14B shows that access to the gas channels 146 is needed to form wire chases in the top 112 to feed wires and cables therethrough. In FIG. 14A, the inventors discovered that a hole may be drilled into the gas channel as indicated at the large arrow. The inventors further discovered that a slide or sleeve 149 could be placed over the entryway 145, particularly one of uniform thickness, wherein a drill starting hole could be added to the sleeve 149 to enlarge the access hole.

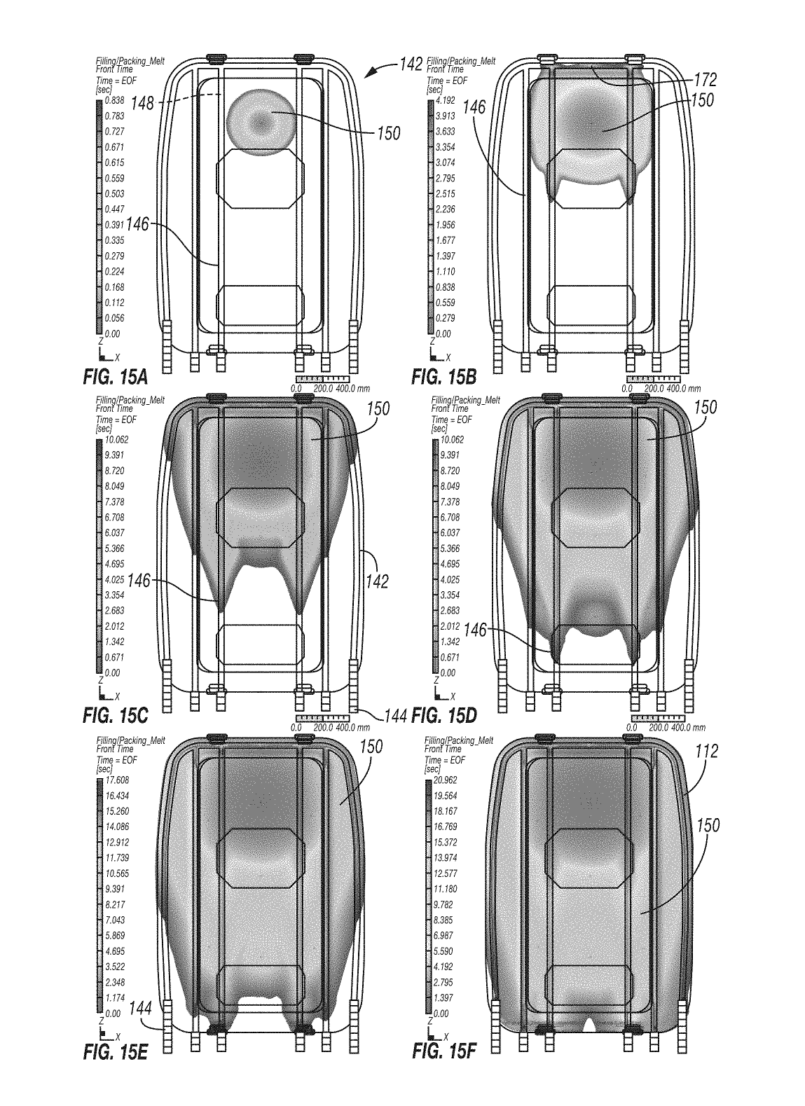

With respect to FIGS. 15A-F, an exemplary filling pattern in the mold 142 is shown. Beginning at segment or stage A (FIG. 15A), molten resin 150 is injected into the mold 42 using a front to back filling pattern. At the appropriate time, the gas port 172 injects the gas 148 into the mold 142. Here, the gas and resin injection points are relatively close to one another to control a path the gas 148 will follow through the cooling resin 150 as shown in FIGS. 15B-C. In this example, the rate of gas flow into the cavities 146 is controlled by the rate of shrinkage of the resin 150; i.e., the gas 148 takes the path of least resistance and flows towards areas of higher shrinkage. The process must be controlled correctly or the gas 148 can undesirably flow out of the gas channels 146 into surrounding areas. The foregoing front to back filling pattern has been discovered to be optimal for clamp tonnage but middle to outside filling patterns have also been used with varying degrees of success.

Experiment Five

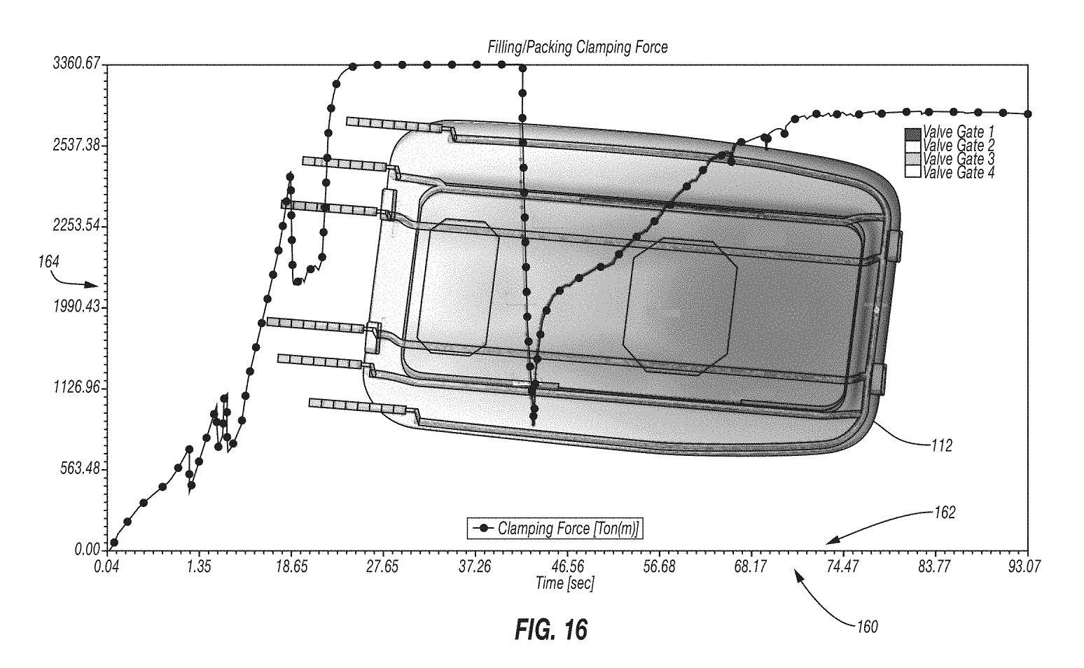

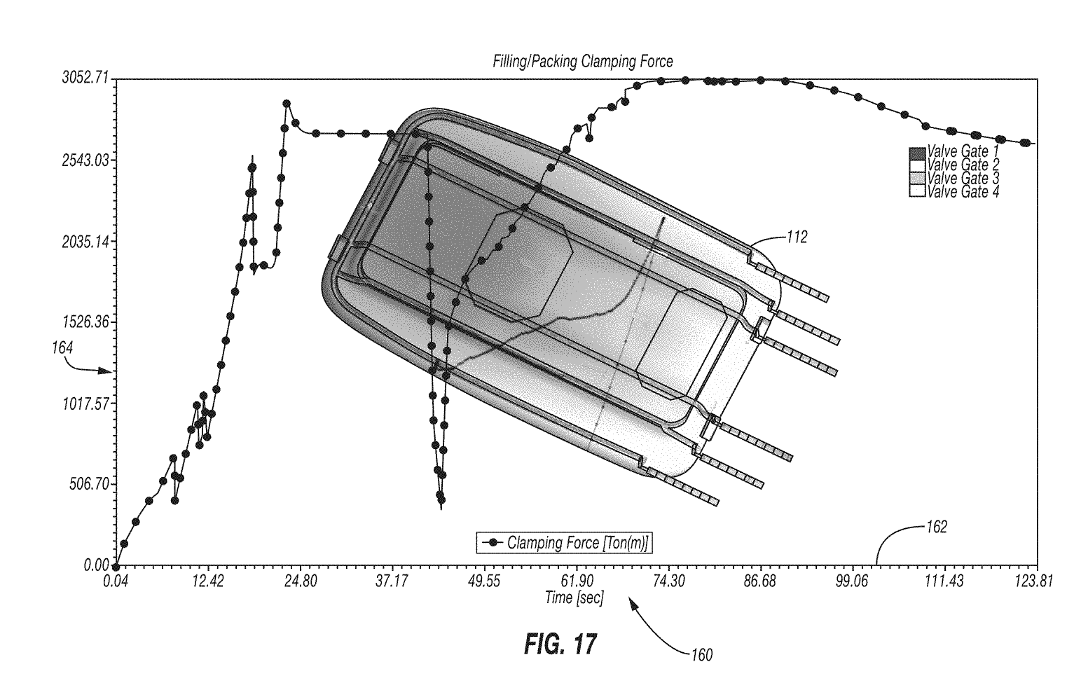

FIGS. 16 and 17 shows clamp tonnage set at approximately 3300 tons using seven (7) valve injection ports for forming the boat top 112 as noted above. Clamp tonnage opposing a separating force is caused by injecting the molten resin 150 into the mold 142 at the pressures similar to those noted with respect to FIG. 7 above. Here, clamp tonnage results are shown in chart 160 in which time-in-seconds is shown along x-axis 162 and force in tons is shown along y-axis 164.

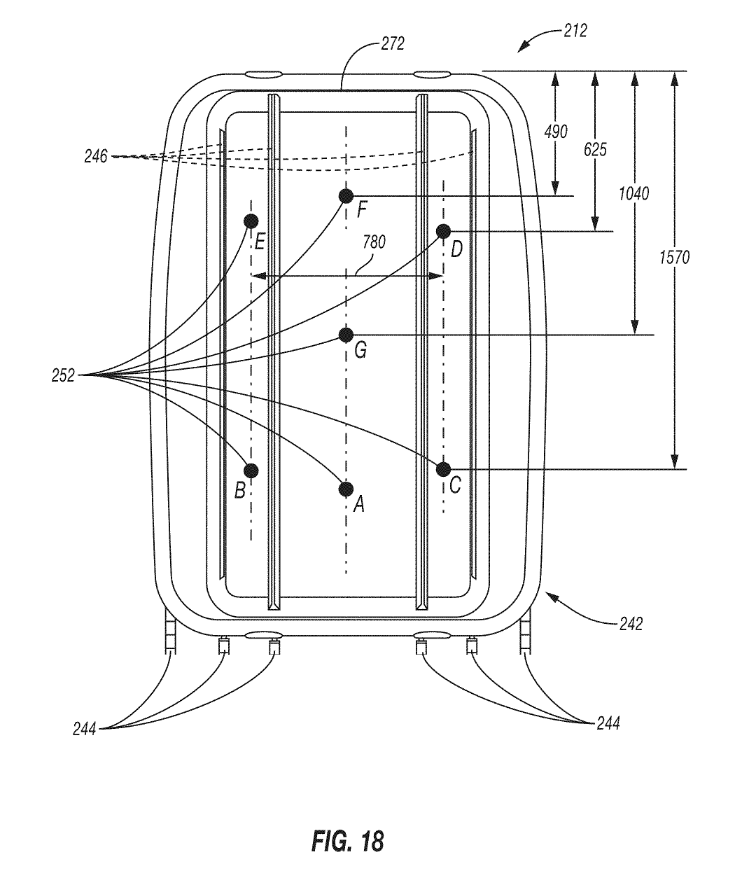

Turning now to FIG. 18, another aspect of the disclosure is shown in which a boat top mold 242 is provided with one or more gas ports, nozzles or gates 272 in communication with the mold 242 to form a boat top 212 using GAIM processes as disclosed herein. As shown, the mold 242 may be made of P20 steel to ensure a high gloss finish in the top 212. In an exemplary process, seven (7) plastic injection valves or gates 252 and six (6) overflow wells 244 may be utilized to push resin into the mold 242 and then to remove unwanted resin from wire chase channels, which will be used to conceal wiring, cables and the like within the boat top 212. In this example, the injection ports 252 are approximately 10 mm in diameter to control the flow characteristics of the resin and manage the pressure and clamping forces.

Experiment Six

FIG. 18 further shows that a midpoint injection port 252A is substantially in line with ports 252B and 252C, which are spaced at or around 1570 mm (approximately 5.41 feet) from one end of the boat top 212. Also shown, injection ports 252D and 252E are spaced at or around 625 mm from the end of the boat top 212 and at or around 780 mm from each other. Injection port 252F is at or around 490 mm (closest to gas port 272), and port 252G is at or around 1040 mm from the end of the boat top 212. The inventors discovered that by aligning the ports 252A-C a plastic fill shape is improved. More specifically, by moving injection port 252A toward a midpoint helps resin flow consistency, which may cause undesirable weld lines or air traps.

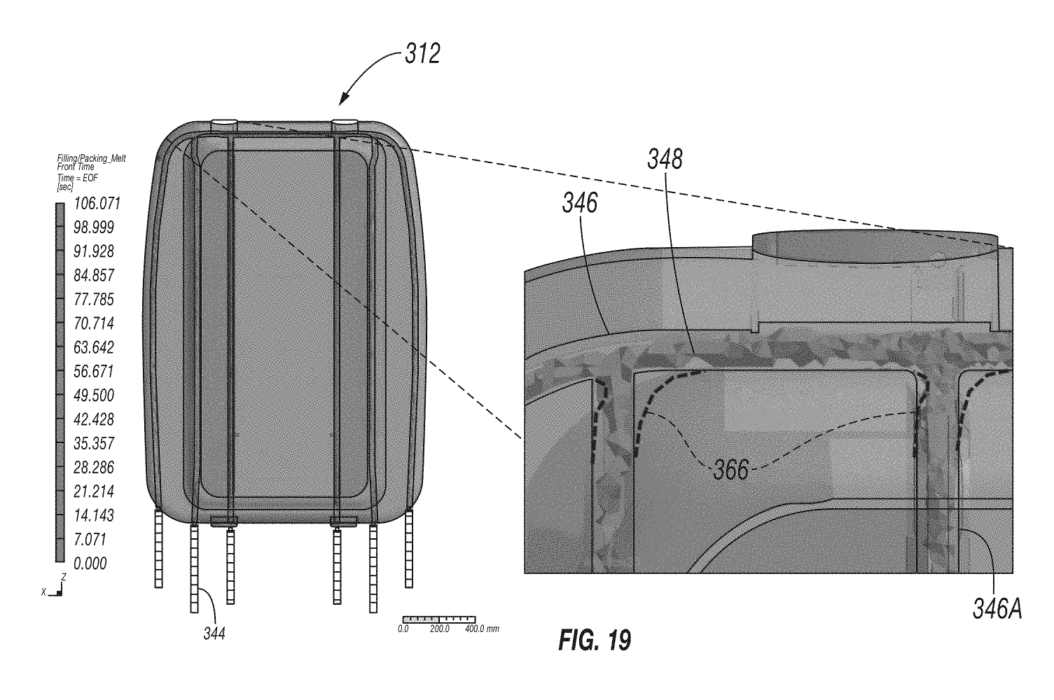

FIG. 19 shows a bottom plan view of a boat top 312, particularly showing gas flow 348 during filling and packing. As shown, the gas 348 flows through all gas channels 346 and displaces plastic into an overflow well 344. Importantly, gas flow 348 is shown in inner gas channels 346A, which are used to feed wires (not shown). Also shown most clearly in the inset of FIG. 19, modified plots 366 (in dashed lines) show areas of the gas channels 346 that can be changed to reduce a normal angle and improve gas transition. This modification also permits easier cable or wire threading into the formed channels.

Experiment Seven

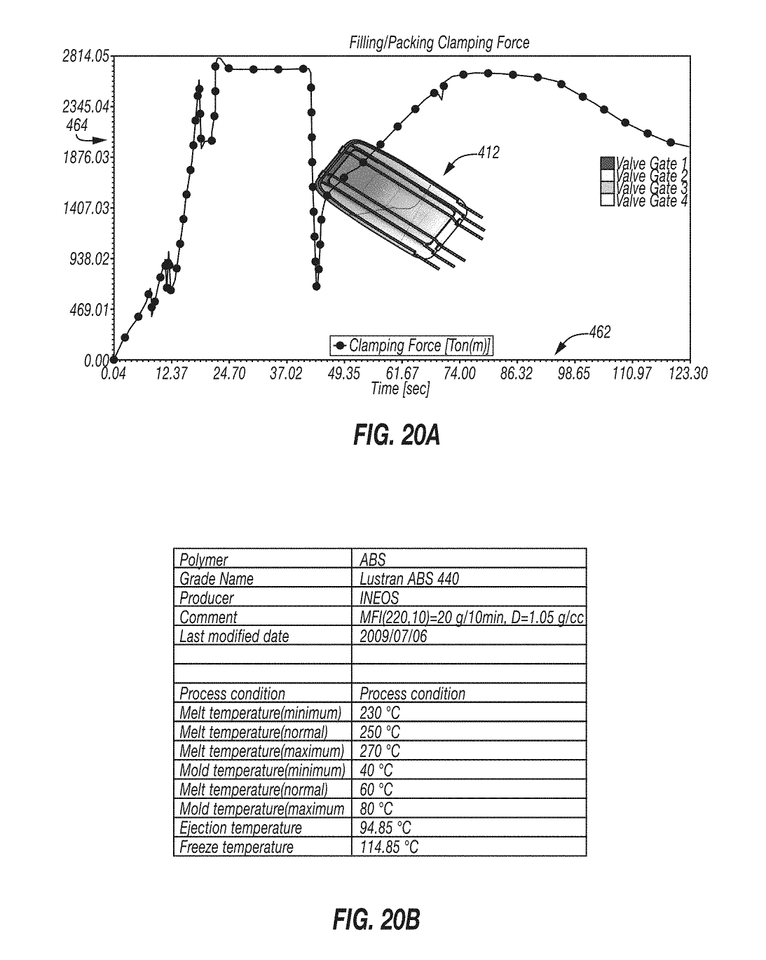

FIGS. 20A and 20B show an exemplary filling process and metrics used therewith to mold a top 412. As particularly shown in FIG. 20A, clamp tonnage 464 slightly exceeds 2800 metric tons at end of filling. FIG. 20B shows material data used in this example. Here, ABS was utilized, and a 20-second filling time 462 at a 270° C. melt temperature in an 80° C. mold is employed.

With reference now to FIG. 21, an overflow pin method for automating the use of overflow wells 544 is shown. Overflow wells 544 ensure that channels/wire chases 532 are cored completely with gas. Here, plastic 550 such as ABS is injected with an overflow pin 570 in a closed position. When the pin 570 is retracted, the plastic 550 is pushed by gas pressure into the well 544 thereby opening the wire chase channel 532. The amount of plastic 550 that flows out of the cavity 532 is controlled by the size of the overflow well 544. Sometimes the pin 570 can be returned to the forward position if the desired component parameters include sufficient thickness. This de-gates the overflow and displaces the plastic above the pin 570 back into the cavity. Alternatively, the pin 570 can remain in the back position and the pillar of plastic can be ejected and removed from the press.

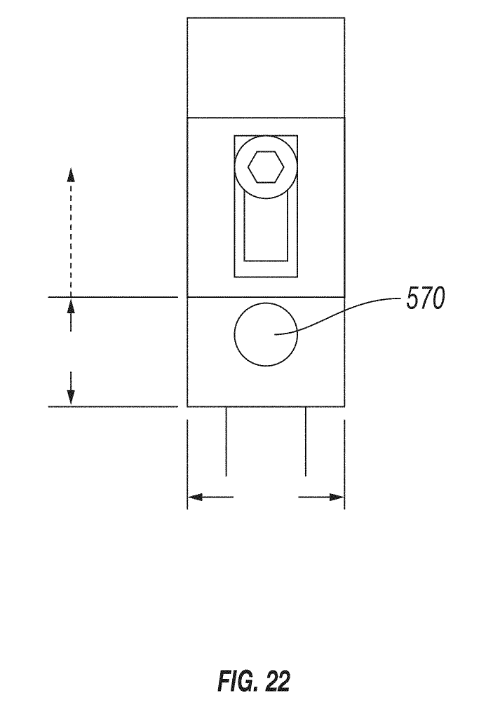

Turning to FIG. 22, an exemplary overflow design is shown. FIG. 22 shows particularly an overflow well that can be altered in size, as shown by the dashed arrow, to accommodate plastic changes displaced by changing process conditions. Also, the overflow pin 570 can be adjusted to suit a particular mold, as indicated by the double arrow size indicator. Preferably but without limitation, the following dimensions may be used:

| Component/Aspect | Dimension | Notes |
|---|---|---|
| Overflow pin | 16.0 mm diameter | Minimize overflow pin stroke |
| Overflow gate | 10.0 mm diameter | — |
| Overflow volume | Approximately | *For outer and middle |
| | 500 cc* | overflows and smaller for |
| | | inner overflow. |

In further relation to FIG. 22, the runner to the overflow well is likely to be 16 mm². It may be necessary or desirable to have a second overflow (i.e., an overflow for an overflow) attached to the inner overflow in the light housing to ensure that the gas channel fully cores out. As discussed below, the overflow volume will include the volume of the retracted pin, sub-gate, and runner. The overflow volume should be adjustable, and the inventors have discovered that the overflow should not be made too thick as it could cause plastic to “jet” and make it difficult to handle as the component is ejected. Preferably, the overflow pocket should be no more than 20 mm deep with a +15° draft.

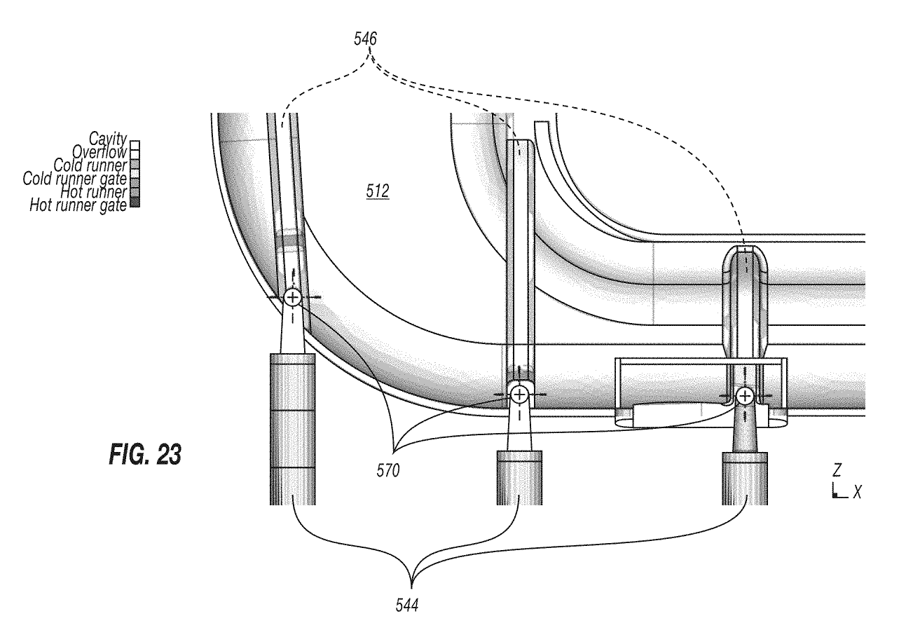

FIG. 23 shows overflow pin locations at the ends of gas channels 544 according to an exemplary arrangement. In this example, 16 mm pins 570 are utilized to minimize gas pressure required to burst through the melt as gas is injected.

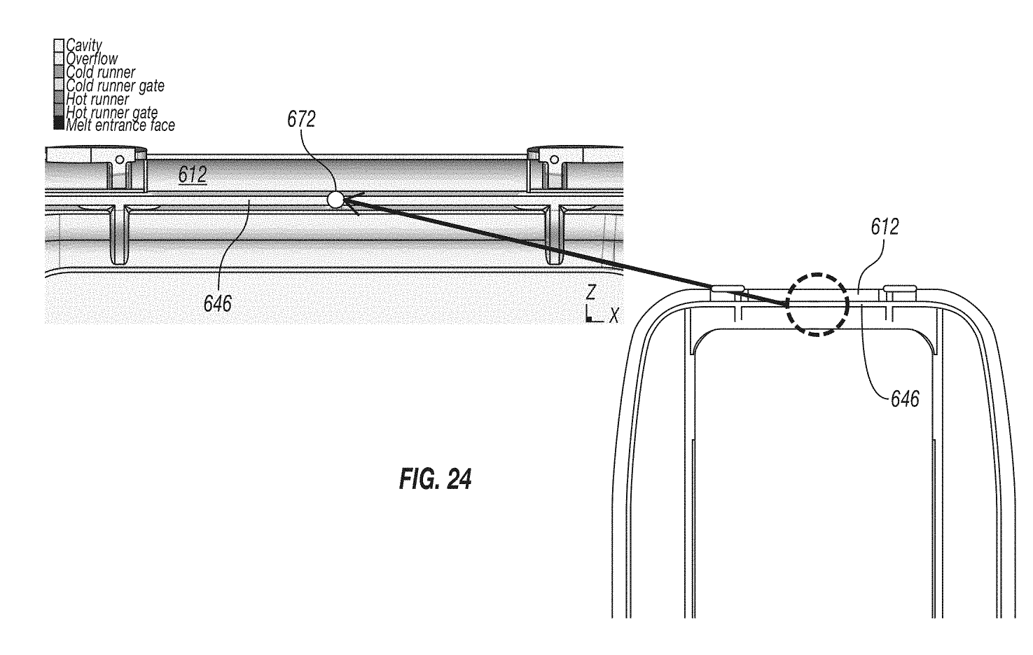

In FIG. 24, an inset shows a single, 10 mm (body diameter) gas nozzle 672 fitted on a mold 612. Here, the nozzle 672 may be fitted with a high flow cap and positioned in the middle of the mold 612 to feed gas directly into the top gas channel 646.

With further overall reference to FIGS. 18-24, the inventors discovered through experimentation that desired clamp tonnage and gas flow are best achieved using a high-flow ABS at close to maximum melt temperature. Clamp tonnage is achieved by opening and then closing plastic injection ports during filling, but all injection ports are open during packing with a maximum packing pressure of 10 MPa (100 Bar specific or 10 Bar hydraulic on a 10:1 ratio machine). Further, gas pressure is limited by clamp tonnage; therefore, a maximum of 8 MPa (80 Bar) can be used to achieve the clamp. As gas pressure is generally low for a length of a gas channel and the material used (ABS), overflow pins are preferably larger than usual, e.g., 16 mm pins are favored although the disclosure is not limited to this example. The inventors also discovered that the process window can be a very short or limited time; therefore, it is important that critical gas channels are cored fully, and a 2-stage overflow can be desirable to allow gas to core the channel and maintain pressure followed by blow through.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

That which is claimed is:

1. A boat top, comprising:
an injection-molded, polymer upper portion and a complementary polymer inner portion molded therewith; and
a wire chase formed contemporaneously by gas injection with the injection-molded upper and inner portions, the wire chase being formed therebetween and configured to accommodate wiring between the upper and inner portions.

2. The boat top as in claim 1, wherein the polymer is selected from the group consisting of polyethylene, polypropylene, polyacrylonitrile and polyvinyl chloride.

3. The boat top as in claim 1, wherein the polymer is acrylonitrile butadiene styrene.

4. The boat top as in claim 1, wherein the inner portion includes a recess in communication with the chase, the recess being configured to receive a device selected from the group consisting of a speaker, a control panel, a light and combinations thereof, the wiring being disposed through the chase to the device.

5. The boat top as in claim 1, further comprising framework being configured to mate the boat top to a boat.

6. The boat top as in claim 5, wherein the framework includes a hollow tube in communication with the chase, the hollow tube being configured to receive the wiring from the chase to power a device selected from the group consisting of a speaker, a control panel, a light and combinations thereof.

7. A boat top system, comprising:
a thermoplastic boat top having an injection molded upper portion and a complementary inner portion and a channel formed therebetween by injected gas, the channel configured to conceal power cables within the boat top; and
framework for mating the boat top to a boat.

8. The boat top system as in claim 7, wherein the thermoplastic boat top is made of a material selected from the group consisting of polyethylene, polypropylene, polyacrylonitrile and polyvinyl chloride.

9. The boat top system as in claim 7, wherein the thermoplastic boat top is made of acrylonitrile butadiene styrene.

10. The boat top system as in claim 7, wherein the inner portion includes a recess in communication with the channel, the recess being configured to receive a device selected from the group consisting of a speaker, a control panel, a light and combinations thereof, the cables being disposed through the channel to the device, and wherein the framework includes a hollow tube in communication with the channel, the hollow tube being configured to receive the cables from the channel to power the device.

11. A method for molding a thermoplastic boat top, the method comprising:
providing a mold having at least one gas channel defined therein and at least one valve gate formed therein;
providing a gas port in communication with the gas channel;
providing a resin port in communication with the valve gate;
heating a quantity of resin to a molten state to achieve a desired viscosity;
injecting the molten resin through the resin port into the mold;
injecting gas from the gas port into the gas channel at a desired pressure to form wire channels in the molten resin; and
forming a boat top with the wire channels therein as the molten resin cools in the mold.

12. The method as in claim 11, wherein the resin is a thermoplastic material.

13. The method as in claim 11, wherein the resin is from about 20 kg to about 30 kg of acrylonitrile butadiene styrene material.

14. The method as in claim 11, wherein the desired gas pressure is from about 1,000 psi to about 2,000 psi.

15. The method as in claim 11, wherein the desired gas pressure has an equivalent clamp tonnage of about 2000 tons to about 4000 tons.

16. The method as in claim 11, wherein the gas port is a plurality of gas ports.

17. The method as in claim 11, wherein the valve gate is a plurality of valve gates.

18. The method as in claim 11, further comprising aligning the wire channels with conduits formed in a framework, the framework being configured to connect the boat top to a boat, the conduits being configured to enclose cables therein.
